(19) United States
(12) Patent Application Publication
(10) Pub. No.: US 2003/0185492 A1
(43) Pub. Date: Oct. 2, 2003

(54) Optical switching matrix arrangement

(75) Inventors: Peter Bucker, Reutlingen (DE); Rolf Goring, Jena (DE); Bernt Gotz, Zollnitz (DE); Thomas Martin, Jena (DE)

Correspondence Address: Klaus P.Stoffel Esq, Ostrolenk Faber Gerb & Soffen LLP, 1180 Avenue of the Americas, New York, NY, 10036-8403, US

(73) Assignee: Piezosystem Jena Prazisionsiustierelemente GmbH,

(21) Appl. No.: 10/117,546

(22) Filed: Mar. 28, 2002

(51) Int. Cl. G02B 6/35; G02B 6/34

(52) U.S. Cl. 385/17; 385/36

(57) ABSTRACT

An optical switching matrix arrangement for optical communication and information networks based on optical fibers, including M different optical collimated input channels defining light beams and N optical collimated output channels defining light beams, each input channel being connected to a different output channel. A total of N² transmitting and deflecting prisms introducable into paths of the beams at intersections of the M collimated input beams and the N collimated output beams so as to deflect the input-side light in a controlled manner onto corresponding output channels. A plurality of piezoelectric bimorph actuators are provided so that one of the actuators is assigned to each of the deflecting prisms for moving the prism, M=N or M≠N.

The invention pertains to an optical switching matrix arrangement, especially for optical communication and information networks based on optical fibers, where a number N of different optical input channels can be connected in any desired manner to a number N of optical output channels, according to the introductory clause of claim 1 or claim 2.

Arrangements for the reconfiguration of optical pathways in optical communication or information networks based on optical fibers are known. Mention can be made here, for example, of the article by Neumeier, Michel et al., “Miniaturized fiber optical switches with non-moving polymeric mirrors for tele- and data communication networks fabricated using the LIGA technology”, in SPIE, Vol. 3276, pp. 37-43.

In arrangements such as this, a number of N different optical input channels must be connected in any desired way to the optical output channels. In most cases, all N connections must be usable in parallel; that is, a switching matrix of this type must operate without any channels being blocked.

Known optical switching matrices with N optical input and output fibers either make use of, for example, the movement of the optical fibers themselves or move comparatively large optical components in the path of the collimated beams between the fiber inputs and outputs. Switching matrices of this type are extremely slow, relatively large, and expensive to produce.

Integratable optical switching matrices as proposed at SPIE, Conference on Microelectronic Structures and MEMS for Optical Processing IV, Santa Clara, September 1998, published in SPIE, Vol. 3513, make use of a torsion mirror arrangement. Different input and output fibers can be coupled by moving the mirrors into different positions, the mirrors being swivelled into position in the path of the beam between opposing input and output fibers.

Switching matrices based on thermally controlled optical waveguide structures in glass are also known. Here the switching times are already in the advantageous range of a few milliseconds, but the losses and the crosstalk between the channels in a matrix of this type are very high, and a relatively large amount of electric power is required to hold the switching states.

A switching matrix arrangement for optical communication and information networks based on optical fibers is known from DE 195-00,214 A1, but here at least one mirror is aligned as desired and moved into the path of the beam, so that the light can be reflected by the mirror toward the entry surface of the desired output line. Because the deflection angles are around 90°, the reflection principle used here means that the arrangement must be adjusted with an extremely high degree of accuracy, and this leads to a considerable amount of work on the production side.

The same is also true for the switching matrix arrangement according to U.S. Pat. No. 5,841,917, which refers to the use of prisms as the optical elements of a matrix, these prisms being attached to the ends of so-called “pins” so that they can be introduced into the path of the beam. Each pin has its own mechanical actuator, which resembles those used in so-called matrix printers.

Against the background presented above, the task of the invention is to provide an improved optical switching matrix arrangement which is capable of rapid switching cycles and which can be produced at low cost with modest technological effort.

The task of the invention is accomplished with a switching matrix arrangement according to the features of claim 1 or claim 2. The subclaims comprise embodiments and elaborations which are at least efficient.

The basic idea of the invention is to start with a switching matrix in which the N input fibers and N output fibers, which lie on a plane, are each provided with a collimating or focusing lens. The light emerging from the input fibers is then collimated, and the appropriately switched beams are focused on the output fibers. According to the invention, transmitting-deflecting prisms are introduced into the paths of the beams at the intersecting or nodal points of the N collimated input beams and the N collimated output beams to switch the configuration of the pathways, each prism deflecting one of the input beams onto one of the output fibers.

According to the invention, therefore, N² prisms are required overall, N of these prisms being in the paths of the beams at all times to deflect them. The others are located outside the paths of the beams and are thus nonfunctional until the switching operations which requires their use is initiated. To reconfigure the optical connections, 2 . . . N prisms are removed from the beam path and correspondingly 2 . . . N other prisms are inserted into the beam path.

According to the invention, furthermore, the deflecting prisms are arranged on a comb structure made of piezoelectric bimorph actuators. Each deflecting prism therefore has its own piezoelectric bimorph actuator. The prisms are preferably connected to the freely movable end of the reed or comb structure in some integral way. The range of movement of the piezoelectric bimorph actuators is greater than the diameter of the collimated beam, i.e., in the range of approximately 500 μm, to ensure an optimal switching process. The height of the prism itself is also greater than the diameter mentioned.

It has been found that the use of prisms for transmission according to the invention is advantageous because, in comparison with mirrors or reflecting prisms, the effort required to adjust them is considerably less and thus the costs associated with installation and production can be minimized. The integral connection between the prism and the reed of the associated piezoelectric bimorph actuator can be achieved by means of soldering or adhesive bonding.

As in the case of standard piezoelectric actuators, the piezoelectric bimorph actuators are driven by the application of current and voltage to them in a manner known in and of itself, which therefore does not need to be explained in any greater detail here.

The invention is explained in greater detail below on the basis of an exemplary embodiment with the help of the figures:

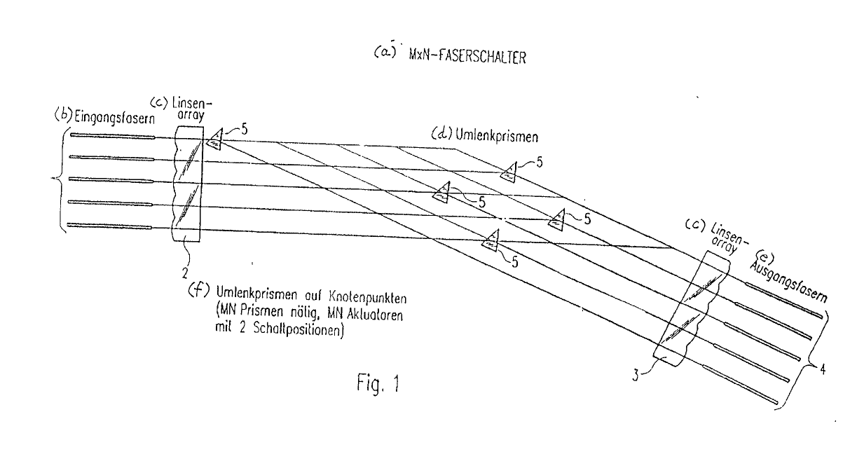

FIG. 1 is a diagram of the arrangement of M×N fiber switches with a lens array provided on both the input and output sides; and

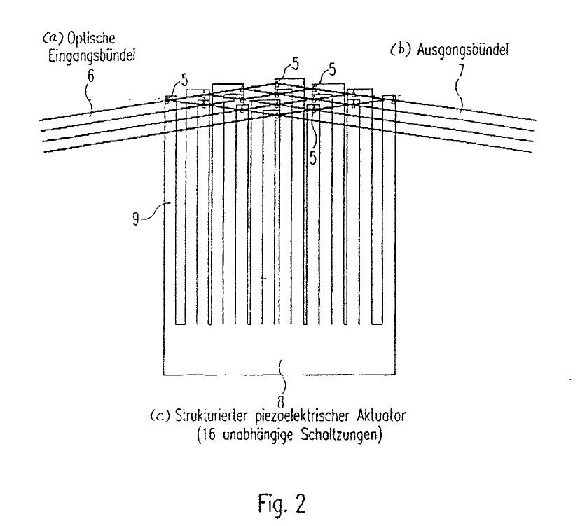

FIG. 2 is a diagram of a structured piezoelectric actuator with, by way of example, 16 independently drivable switching reeds.

As can be seen in FIG. 1, the input fibers 1 are guided to a first lens array 2. The light emerging from the input fibers 1 is collimated, i.e., focused on the second lens array 3, which is on the output side, leading to the output fibers 4.

To switch the pathways, deflecting microprisms 5 are introduced in a defined manner into the paths of the beams at the points where the collimated input beams 6 and the correspondingly collimated output beams 7 intersect.

The prisms 5 are designed in such a way that each of the input beams is deflected on the emission side toward a corresponding output fiber 4. If required for certain applications, it is also possible for a beam to be deflected in such a way that the radiation of an input beam 6 falls on several output fibers 4. For multichannel applications, it is also possible to arrange the prisms and their associated bimorph actuators in a stack.

In concrete terms, the deflecting prisms 5, as shown schematically in FIG. 2, are moved by a piezoelectric bimorph actuating arrangement 8, that is, by piezoelectric actuators. The prisms are deflected at a right angle to the switching plane by appropriate piezoelectric bimorph actuators, that is, by the corresponding reeds 9 of the comb structure, one of which reeds is assigned to each prism. The range of movement or range of adjusting angles of each piezoelectric bimorph actuator is greater than the diameter of the associated collimated beam in order to ensure an optimal switching process; this range is, for example, essentially around 500 μm.

The individual prisms are attached integrally to the upper, free end of each reed of the comb structure by, for example, soldering or adhesive bonding.

Individual reeds or groups of reeds of the piezoelectric bimorph actuator can be moved by the application of an electrical voltage, and when the reeds move, they carry along their associated prisms, as a result of which the beams of collimated light are switched, that is, deflected.

The comb structure of the piezoelectric actuator can be fabricated out of structured ceramic in the known manner, and as long as the flexural elasticity and the necessary deflection angles of the individual reeds are ensured, the overall arrangement can be miniaturized to a significant degree.

Overall, the switching matrix arrangement according to the invention makes it possible to build extremely compact optical switches at low cost for use in communication and information networks, for example, and as a result of the less critical optical surfaces of the prisms, the production and installation cost an also be reduced.

### LIST OF REFERENCE NUMBERS

1 input fibers

2 first lens array

3 second lens array

4 output fibers

5 deflecting microprisms

6 optical input beam

7 optical output beam

8 piezoelectric bimorph actuating arrangement

9 reed

1. Optical switching matrix arrangement, especially for optical communication and information networks based on optical fibers, where M different optical input channels and N optical output channels are provided, and where each input channel is connected to a different output channel, characterized in that transmitting and deflecting prisms can be introduced into the paths of the beams at the intersections of the M collimated input beams and the N collimated output beams, which prisms deflect in a controlled manner the input-side light onto the corresponding output fibers, where each of the total of N² deflecting prisms is moved by its own assigned piezoelectric bimorph actuator, and where M=N or M≠N.

2. Optical switching matrix arrangement, especially for optical communication and information networks based on optical fibers, where M different optical input channels and N optical output channels are provided, and where each input channel is connected to a different output channel, characterized in that prisms can be introduced into the paths of the beams at the intersections of the M collimated input beams and the N collimated output beams, which prisms deflect the input-side light in a controlled manner onto the corresponding output fibers, where each of the total of N² deflecting prisms is moved by its own assigned piezoelectric bimorph actuator, where the piezoelectric bimorph actuators form a comb structure, and where M=N or M≠N.

3. Arrangement according to claim 1 or claim 2, characterized in that, to ensure an optimum switching process, the range of movement of the piezoelectric bimorph actuators and the height of the prisms are greater than the diameter of the collimated beams.

4. Arrangement according to claim 1, characterized in that the piezoelectric bimorph actuators have a comb structure, where a prism is attached in an integral manner to each reed of the comb structure.

5. Arrangement according to one of the preceding claims, characterized in that the range of movement or stroke of the bimorph actuators is essentially in the range of 500 μm.

6. Arrangement according to one of the preceding claims, characterized in that the input and output beams lie on a plane.
